(19) United States
(12) Patent Application Publication
(10) Pub. No.: US 2025/0316934 A1
(43) Pub. Date: Oct. 9, 2025

(54) Enclosure for Electrical Connector

(71) Applicant: Solaredge Technologies Ltd., Herzeliya (IL)

(72) Inventors: Ilya Gluzman, Rosh Ha'ayin (IL); Noam Dahan, Tel Aviv (IL); Ido Debi, Ramat Gan (IL); Yariv Shlivinski, Ramat Hasharon (IL); Liron Har-Shai, Tel Mond (IL); Yuval Heimer, Shoham (IL); Ohad Gidon, Netanya (IL); Roy Shkoury, Hadera (IL)

(21) Appl. No.: 19/098,638

(22) Filed: Apr. 2, 2025

Related U.S. Application Data
(60) Provisional application No. 63/574,395, filed on Apr. 4, 2024.

(51) Int. Cl. H01R 13/66; H01R 13/50; H01R 13/518

(52) U.S. Cl. CPC H01R 13/6683; H01R 13/501; H01R 13/518; H01R 13/6675

(57) ABSTRACT

Systems and methods are described herein for an electrical system comprising a mechanical connector and a retrofit enclosure configured to be disposed over the connector. The adapter may comprise a controller configured to maintain safe provision of power, such as by detecting a potential overheating and/or arcing conditions. For example, the controller may detect changes in temperature, voltage, current and/or acoustic noise associated with the mechanical connector, and take responsive action.

### CROSS-REFERENCE TO RELATED APPLICATIONS

This application is a non-provisional of and claims priority to U.S. Provisional Application No. 63/574,395, filed Apr. 4, 2024, the content of which is incorporated herein by reference in its entirety.

### BACKGROUND

Electrical systems include mechanical connectors, which may be susceptible to arcing and/or overheating in case of poor connection. Arc detection and overheating detection circuits might not always be disposed in sufficient proximity to detect overheating and/or arcing conditions at all connection points. There is a need for improved solutions for detecting faulty connections and possible effects thereof.

### SUMMARY

The following summary presents a simplified summary of certain features. The summary is not an extensive overview and is not intended to identify key or critical elements.

Apparatuses, systems, and methods are described for an electrical system comprising mechanical connectors and retrofit enclosures configured to be fastened over the mechanical connectors. The retrofit enclosures may comprise sensors/sensor interfaces configured to measure one or more parameters and provide the measurements to a controller. The parameters may include electrical and/or other physical properties, such as voltage, current, temperature, light, electrical field, noise (e.g. electrical noise or acoustic noise). The controller may be employed to receive sensor measurements, perform calculations, detect a potential overheating and/or arcing condition, and take responsive action. In some cases, the controller may communicate (e.g., via a wired or wireless communication device) the measurements to one or more additional controllers, with the additional controllers configured to perform calculations to determine if a potential overheating condition is present and/or to take responsive action.

The responsive action may include sending a shutdown signal to one or more devices. The responsive action may include injecting a signal or noise on a power line to cause one or more devices to detect a potentially dangerous condition. The responsive action may include sending a notification to one or more electronic devices. The responsive action may include emitting a visual and/or audible alarm.

The enclosure may comprise a power supply (e.g., an auxiliary power circuit) configured to be inductively coupled to a power line coupled to a mechanical connector disposed within the enclosure. The power supply may draw operational power from an alternating current signal superimposed on the power line, and may utilize the operational power to power the sensors/sensor interface(s), the controller, the communication device and/or any other active electronics disposed in the enclosure. In addition to or instead of an inductively coupled power supply, the enclosure may comprise a photovoltaic power supply and/or a battery configured to provide operational power to devices comprised by the enclosure.

The enclosure may be made of one or more fire-resistant materials, and/or may be mechanically designed to suppress fire spreading in case of a failure of the active electronics to effectuate a system shutdown in a timely manner.

The enclosure may be configured to fit over a single connection point, or may comprise several detection circuits and may be mechanically designed to fit over multiple connection points (e.g., in a combiner box).

Various methods are disclosed herein for effective detection of faulty connections and responses. For example, methods disclosed herein may include a single-step detection mechanism configured to provide fast shutdown in case of a suspected unsafe condition. Methods disclosed herein include a multi-step detection mechanism configured to reduce false-positive and false-negative detections.

These and other features and advantages are described in greater detail below.

### BRIEF DESCRIPTION OF THE DRAWINGS

The following summary presents a simplified summary of certain features. The summary is not an extensive overview and is not intended to identify key or critical elements.

Some features are shown by way of example, and not by limitation, in the accompanying drawings. In the drawings, like numerals reference similar elements.

FIG. 1A shows an example connector enclosure.

FIG. 1B shows an example connector enclosure.

FIG. 2 shows an example connector enclosure.

FIG. 3 shows an example flow diagram.

FIG. 4A shows an example connector enclosure.

FIG. 4B shows an example connector enclosure.

FIG. 5 shows waveforms associated with an example connector enclosure.

FIG. 6 shows example connectors.

FIG. 7 shows example connectors.

FIG. 7A shows example connectors.

FIG. 7B shows example connectors.

FIG. 8A shows a voltage-sensing circuit according to aspects of the disclosure discussed herein.

FIG. 8B shows a power device according to aspects of the disclosure discussed herein.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

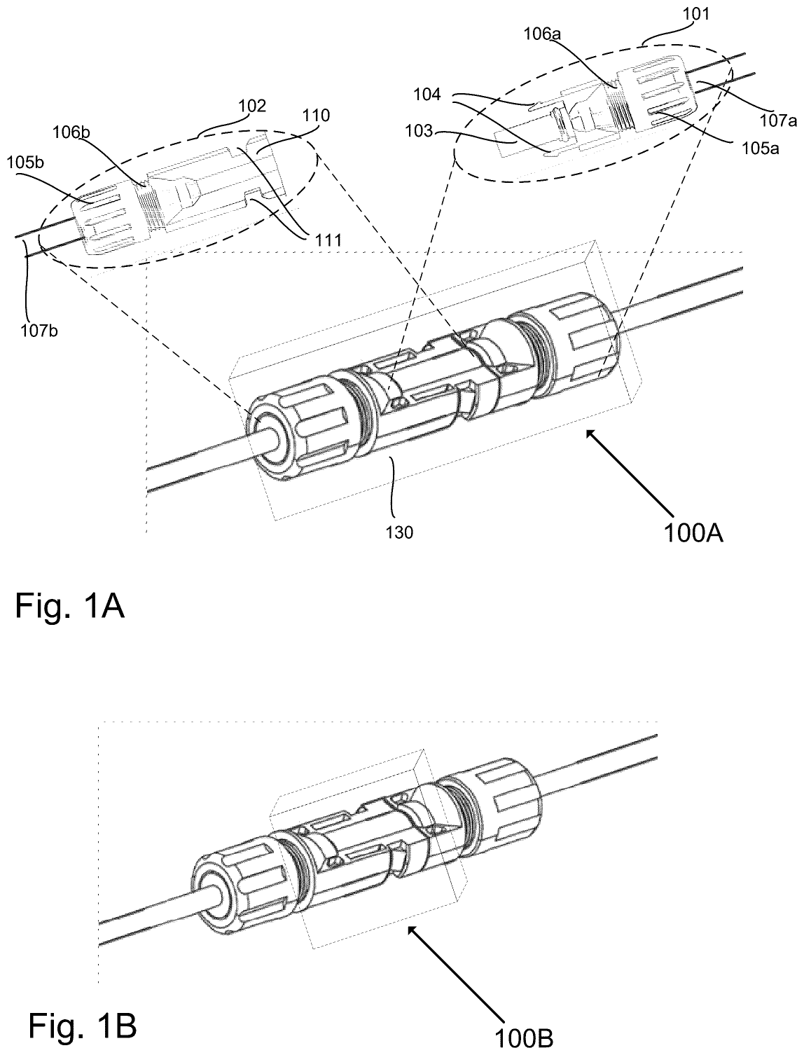

Reference is now made to FIG. 1A, which illustrates a safety enclosure 100A. Safety enclosure 100A is shown schematically encompassing a mating of connector 101 and connector 102. Safety enclosure 100A may encompass any number of shapes, geometries, and configurations suitable to enclose connector 101 and connector 102. Any type of connectors configured to be mechanically and electrically interconnected may be used. In the example shown in FIG. 1A, a male connector 101 is shown connected to a female connector 102. Male connector 101 may comprise mating pin 103, locking pins 104, threading 106a and cable gland 105a. Female connector 102 may comprise mating cavity 110, locking openings 111, threading 106b and cable gland 105b.

Cable gland 105a may be fastened over threading 106a, to fasten cable 107a in place and maintain an electrical connection between cable 107a and a conductive member integrated in mating pin 103 (not visible in FIG. 1A, due to an implied opacity of mating pin 103). Cable gland 105b may be threaded over threading 106b, to fasten cable 107b in place and maintain an electrical connection between cable 107b and a conductive member integrated in mating cavity 110 (also not visible in FIG. 1A).

During mating, mating pin 103 is inserted in mating cavity 110. When male connector 101 and female connectors 102 are mated, the conductive member integrated in mating pin 103 is brought into electronic contact with the corresponding conductive member integrated in mating cavity 110. When male connector 101 and female connectors 102 are mated, locking pins 104 extrude from locking openings 111, thereby locking the connectors in place.

Improper mating of connectors (e.g., male connector 101 and female connector 102), imperfections introduced during manufacturing of connectors, material degradation or ingress of water or dirt may cause a faulty electrical connection between connectors. A faulty electrical connection between connectors may cause an unsafe condition, e.g., an overheating and/or arcing condition, to develop. Absent detection and responsive action, the unsafe condition may cause a fire and pose a danger to people and/or property.

Safety enclosure 100A may comprise a cavity 130 such that it may be retrofitted over connectors (e.g., connectors 102 and 101) and may include sensors/sensor interface(s) (SSI) configured to measure parameters indicating a potentially unsafe condition. Safety enclosure 100A may comprise a controller configured to, based on measurements provided by SSIs, determine whether an unsafe condition has developed or is developing. Safety enclosure 100A may comprise a communication device configured to report a potentially unsafe condition to one or more additional devices (e.g. central controllers), and/or to signal one or more additional devices to modify a mode of operation. Safety enclosure 100A may comprise a power circuit configured to provide operational power to the SSI, the controller and/or the communication device.

Safety enclosure 100A may be made of a fire-retardant material, or may comprise a fire-retardant inner lining configured to suppress a fire in case of failure to trigger a timely response to an overheating condition.

Reference is now made to FIG. 1B, which illustrates a connector or safety enclosure 100B. Safety enclosure 100B is shown schematically encompassing a mating of connectors which may be the same as or similar to connectors 101 and 102 of FIG. 1A. Like connector enclosure 100A, safety enclosure 100B may encompass any number of shapes, geometries, and configurations suitable to enclose mated connectors. Safety enclosure 100B may be similar to and contain substantially similar components to safety enclosure 100A. Safety enclosure 100B may be reduced in size compared to safety enclosure 100A, such that it does not encompass the entirety of the mated connectors, rather, edges of safety enclosure 100B may terminate proximate to a portion of the connectors that are not adjacent to an electrical connection point between the connectors. For example, in the illustration of FIG. 1B, safety enclosure 100B may terminate proximate to threading 106a/106b or cable gland 105a/105b of connectors 101, 102, respectively. Reducing a size of the enclosure such that it does not encompass the entirely of the mated connectors may reduce a cost of manufacturing, shipping, storing or installing the enclosure.

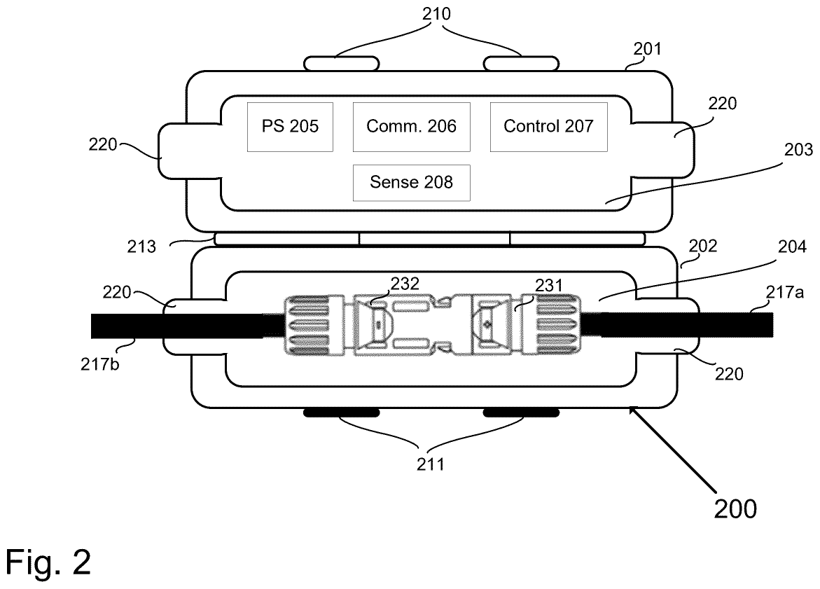

Reference is now made to FIG. 2, which illustrates an example safety enclosure 200 according to the disclosure herein. Safety enclosure 200 may be similar to or the same as safety enclosure 100A of FIG. 1A. Safety enclosure 200 may comprise first and second housing members. For example, safety enclosure 200 may comprise upper lid 201 and lower lid 202. Upper lid 201 may comprise snap-lock rings 210 disposed on a first edge of upper lid 201, and lower lid 202 may comprise snap-lock ridges 211 disposed on a first edge of lower lid 202. Upper lid 201 and lower lid 202 may be connected via hinge 213, configured to enable upper lid 201 to be “swung” towards lower lid 202 and fastened to lower lid 202 by disposing snap-lock rings 210 over snap-lock ridges 211. Alternatively, other fastening mechanisms may be used. For example, upper lid 201 and lower lid 202 may be completely detached prior to field deployment, with upper lid 201 comprising protruding pins configured to be mechanically inserted into corresponding cavities in lower lid 202.

Upper lid 201 may comprise an inner surface and an outer surface, with inner lining 203 disposed on the inner surface. Lower lid 202 may comprise an inner surface and an outer surface, and may comprise inner lining 204 disposed on the inner surface. Inner linings 203 and 204 may be made of comprise fire-suppressing material, for example, high-density polyethylene (HDPF), or other fire-suppressing polymers. Inner linings 203 and 204 may suppress and/or prevent spreading of heat and/or fire from an interior of enclosure 200 in case of an unsafe condition present or developing at a connection point within enclosure 200.

Upper lid 201 may comprise sensor/sensor interface(s) (SSI) 208 disposed on the inner surface of upper lid 201, or on the inner lining of upper lid 201. SSI 208 may comprise one or more sensors configured to detect electrical and/or other physical properties that may be indicative of a potential overheating or arcing condition, such as temperature, light, or acoustic noise. For example, SSI 208 may comprise a temperature sensor configured to sense a temperature at or near an electrical connection point of two connectors. For example, SSI 208 may comprise a photodiode or other light-detection sensor configured to sense light within the enclosure, that may be indicative or sparks, fire, arcing or other potentially unsafe conditions. SSI 208 may comprise an acoustic sensor configured to sense noise (e.g. electrical buzzing or humming, or fire crackling) that may be indicative of an unsafe condition.

Upper lid 201 may comprise a controller 207 and communication device 206. Controller 207 may be configured to receive measurements from SSI 208 and transmit them, via communication device 206, to a different controller for processing, and/or may independently process the measurements to determine a possibility or probability of an unsafe condition developing. Controller 207 may comprise an analog control circuit, a digital control circuit, or a combined analog-digital control circuit. Communication device 206 may comprise a wired communication device (e.g. a Power Line Communication (PLC) modem) and/or a wireless communication device (e.g. a Bluetooth™, WiFi™, Sub-Giga, Ultra Wideband, cellular or other communication device). In some cases, communication device may comprise both a wired communication device configured to transmit and/or receive PLC signals modulated over a cable coupled to connectors, and a wireless communication device configured to wirelessly transmit and/or receive signals to and from a remote device.

Upper lid 201 may comprise power supply (PS) 205, which may be configured to provide operational power to SSI 208, controller 207 and/or communication device 206. In some examples, power supply 205 may comprise a battery and circuitry configured to convert power from the battery to provide operational power to SSI 208, controller 207 and/or communication device 206. In some examples, power supply 205 may comprise a power conversion circuit coupled to a photovoltaic source (e.g., one or more photovoltaic cells) disposed on an exterior of enclosure 200 (for example, configured similarly to solar-powered calculators). In some examples, power supply 205 may comprise one or more windings configured to be inductively coupled to a power cable running through safety enclosure 200, and circuitry to draw power from the windings, and converter and provide the power to SSI 208, controller 207 and/or communication device 206. In the example of FIG. 2, male connector 231 is shown connected, inside safety enclosure 200, to female connector 232. Cable 217a is connected to male connector 231 and cable 217b is connected to female connector 232. Cables 217a and 217b may together form part of a power line. The power line may carry an alternating current (AC) signal superimposed onto the power line at an AC frequency, and PS 205 may be designed to convert the energy superimposed by the AC signal into direct current (DC) power provided to SSI 208, controller 207 and/or communication device 206.

Upper lid 201 and lower lid 202 may comprise cable guides 220 at edges of the safety enclosure, to facilitate secure and safe deployment of power cables within the enclosure. Cable guides 220 may comprise grommet or half-grommets configured to substantially seal around the power cables.

Components and contents of upper lid 201 and lower lid 202 may be interchangeable. For example, one or more of the elements described as being coupled to or part of upper lid 201 may be coupled to or part of lower lid 202, and vice-versa.

The controller may be employed to receive sensor measurements, perform calculations, detect a potential overheating and/or arcing condition, and take responsive action. In some cases, the controller may communicate (e.g., via a wired or wireless communication device) the measurements to one or more additional controllers, with the additional controllers configured to perform calculations to determine if a potential overheating condition is present and/or to take responsive action.

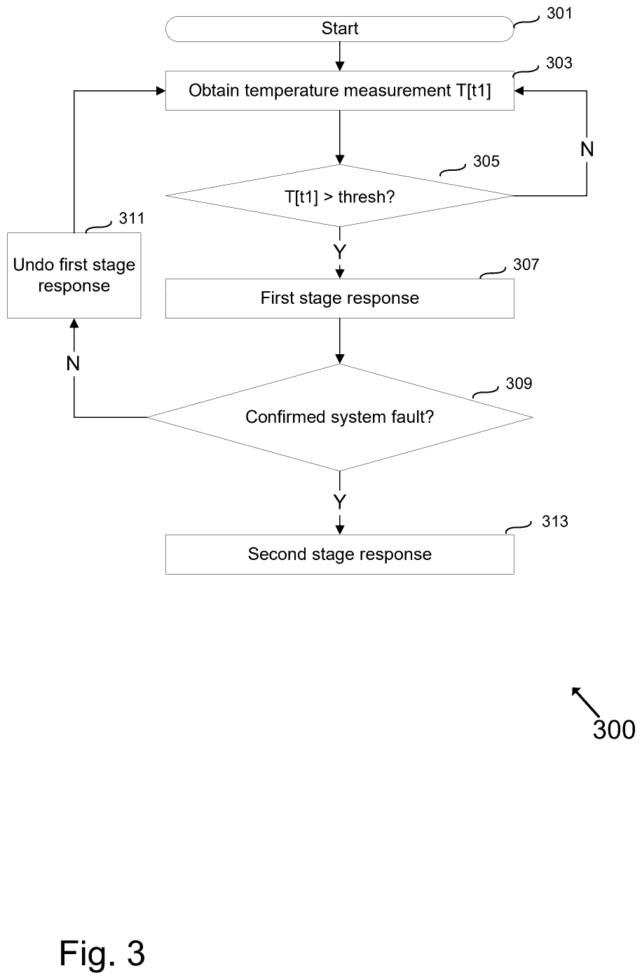

Reference is now made to FIG. 3, which illustrates a method according to the disclosure herein. Method 300 may be carried out by a controller disposed in a safety enclosure, for example, by controller 207 of FIG. 2.

At step 301, the controller (e.g., controller 207) may start the method. At step 303, the controller may receive a temperature measurement measured at time t1 (T[t1]) from SSI 208. At step 305, the controller may compare the temperature measurement to a threshold. The threshold may be a fixed threshold or a dynamic threshold depending on other parameters. If the measurement is determined to be below the threshold, the controller may loop back to step 303 and receive another temperature measurement at time t2. If a connection between the connectors is safe, the controller may alternate between steps 303 and 305 as long as the controller receives operational power.

If, at step 305, the controller determines that the temperature measurement is above the threshold, the controller may proceed to step 307 and activate a first stage response. For example, the first stage response may comprise reporting the temperature measurement or the comparison result to a higher-level control device such a system control device. For example, the first stage response may comprise sending an instruction to a power device (e.g., a DC/DC power converter or DC/AC power converter) coupled to the connector to reduce current flowing through the conductor.

After step 307, the controller may proceed to step 309 and attempt to determine whether an unsafe condition may be confirmed. For example, the controller may continue to monitor temperature measurements provided by SSI 208 and attempt to determine a trend or sustained high values of temperature measurements. For example, the controller may correlate temperature measurements with other measurements provided by SSI 208 and/or received from other communication devices. For example, the controller may correlate the temperature measurements with DC current measurements measured by SSI 208 corresponding to a DC current flowing through the safety enclosure. For example, the controller may compare the temperature measurements to temperature measurements previously measured by SSI 208. For example, the controller may wait to receive a communication from a different controller that may comprise instructions and/or further information.

If, at step 307, the controller determines that an unsafe condition is likely to be present, the controller may proceed to step 313 and may activate a second-stage response. For example, the first stage response may comprise reporting, using a high-urgency protocol or header, the temperature measurement or the comparison result to a higher-level control device such a system control device. For example, the second-stage response may comprise sending an instruction to a power device (e.g., a DC/DC power converter or DC/AC power converter) coupled to the connector to cease current flowing through the conductor.

If, at step 309 the controller determines that an unsafe condition is unlikely to be present, the controller may proceed to step 311, may de-activate the first-stage response (e.g., by sending an appropriate signal) and may loop back to step 303.

Steps of method 300 may be added, removed, be made conditional or executed out-of-order. For example, the controller may proceed directly from step 305 to step 309. For example, the controller may proceed from step 305 to step 307 if the temperature is greater than the threshold by a first amount, and may proceed directly from step 305 to step 309 if the temperature is greater than the threshold by a second amount.

According to other examples, instead of using temperature measurements for detecting a potentially unsafe condition, the controller may use other measurements obtained from SSI 208 to detect a potentially unsafe condition. For example, the controller may use a light sensor (e.g., by comparing light measurements to a threshold) or an acoustic sensor (e.g., by comparing received acoustic measurements to a threshold).

According to other examples, a method carried out by a controller (e.g., controller 207) may be triggered by a specific event and not run periodically. For example, a fuse may be disposed within a circuit coupled to controller 207, the fuse configured to blow at a certain temperature that may indicate a potentially unsafe condition. Upon the fuse blowing, the circuit may change a signal provided to the controller from a logical ‘0’ to a logical ‘1’.Upon receiving the logical ‘1’, the controller may response appropriately (e.g., by sending a signal).

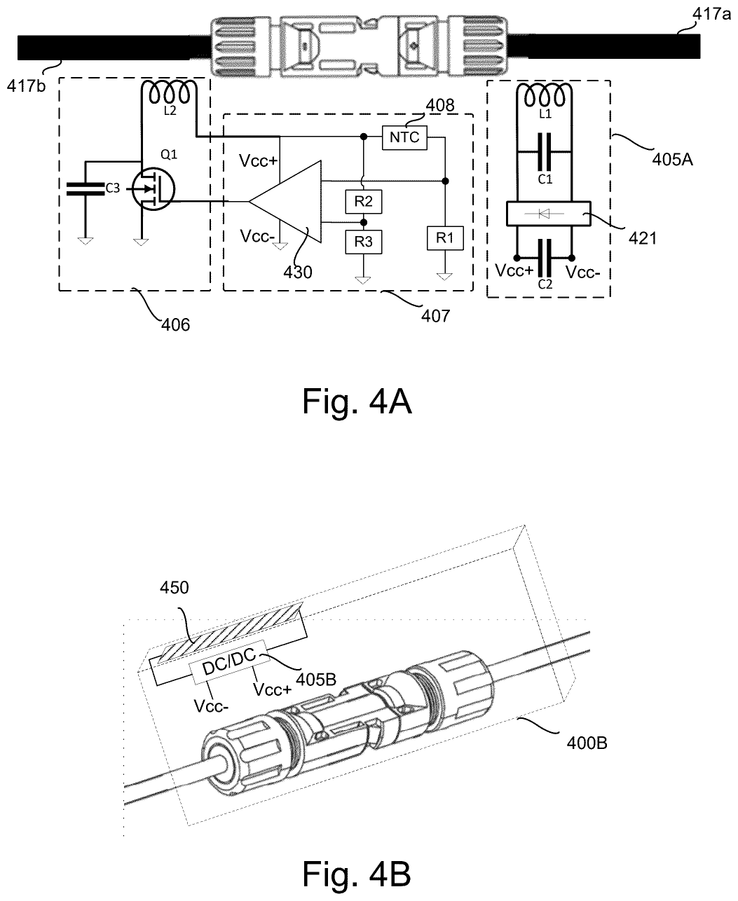

Reference is now made to FIG. 4A, which is a part block-diagram part schematic depiction of example components of an enclosure for an electrical connector, according to a feature of the disclosure herein. Power supply 405A, control circuit 407, and communication circuit 406 may be example implementations of corresponding power supply 205, controller 207 and communication device 206. Power supply 405A may comprise inductor L1, capacitor C1, rectifier 421 and capacitor C2. Inductor L1 may be magnetically coupled to conductor 417a, such that a high-frequency (e.g., kHz, tens or hundreds of kHz) alternating current flowing through conductor 417a may induce a voltage across windings of L1. Capacitor C1 may be coupled in parallel to inductor L1, and may stabilize a voltage induced across L1, and rectifier 421 (e.g., a diode bridge) may rectify the voltage to a substantially constant voltage across capacitor C2. The voltage across C2 may be, for example, a 1.8V, 3.3V DC, 8V or 10V stable voltage, and may be used as a supply voltage for control circuit 407.

Control circuit 407 may comprise a comparator. For example, operational amplifier (op-amp) 430 may be used as a comparator. Supply voltage Vcc may be provided to op-amp 430 via Vcc+ and Vcc− terminals of op-amp 430. Sensor 408, in this example, may be implemented using an NTC (negative temperature coefficient) resistor. NTC resistors are thermally sensitive semiconductor-based resistors which exhibit a decrease in resistance as temperature increases. Sensor 408 may be coupled at one end to supply voltage Vcc, and at a first reference point to resistor R1. The first reference end may be input to a first reference input of op-amp 430, and a second end of resistor R1 may be coupled to a local ground Vcc−. Resistors R2 and R3 may be coupled in series between supply voltage Vcc and ground, and a second reference point between resistors R2 and R3 may be input to a second reference input of op-amp 430. An output of op-amp 430 may depend on a relationship between a voltage of the first reference point and the second reference point. At low temperatures, sensor 408 may exhibit high resistance, and the voltage of the first reference point may be lower than the voltage of the second reference points, resulting in an op-amp output of ‘0’. At higher temperatures (e.g., a temperature above a safety threshold), sensor 408 may exhibit low resistance, and the voltage of the first reference point may be higher than the voltage of the second reference points, resulting in an op-amp output of ‘1’.

The op-amp output may be provided, along with power supply voltage Vcc, as input to communication circuit 406. Communication device may comprise transistor Q1 coupled in parallel to capacitor C3, and inductor L2 coupled in series between the Q1∥C3 parallel connection and supply voltage Vcc. Inductor L3 may be magnetically coupled to conductor 417a and/or conductor 417b. Transistor Q1 may have a control terminal coupled to an output of op-amp 430. When the op-amp output is ‘0’, transistor Q1 may be OFF. When the op-amp output is ‘1’, transistor Q1 may be ON, resulting in resonant current flow between inductor L2 and capacitor C3, which may cause high-frequency current to be induced on conductor(s) 417a and/or 417b. The high-frequency current may be detectable by an upstream device, such as an inverter and/or a smart combiner box, and detection of the high-frequency current may be interpreted as an overheating alarm being raised.

Reference is now made to FIG. 4B, which is part block-diagram part schematic depiction of example components of an enclosure for an electrical connector, according to a feature of the disclosure herein. Photovoltaic (PV) power source 450 (e.g., one or more photovoltaic cells) may be disposed on an exterior of enclosure 400B, which may be similar to or the same as enclosure 100A of FIG. 1A. DC/DC conversion circuitry 405B may be disposed on an interior of enclosure 400B, and may convert power generated by PV power source 450 to a DC power supply suitable for power control and communication circuitry (e.g. control circuit 407 and/or communication circuit 406 of FIG. 4A). Where PV power source 450 is the only power source provided for powering other components of enclosure 400B, circuitry of enclosure 400B might not function at nighttime or when no sunlight is available. PV energy systems may remain safe even under these conditions, as when sunlight is not available (e.g. at night), the entire energy system might not be producing power. Where enclosure 400B is used in a system including other power sources (e.g. batteries), enclosure 400B may include a power source in addition to PV power source 450, for example, a battery that may be charged by PV power source 450 when sunlight is available, and/or power supply 405A of FIG. 4A.

Additional analog or digital power harvesting, control and/or communication circuitry may be included in enclosures 100A, 100B, 200, 400B according to the disclosure herein.

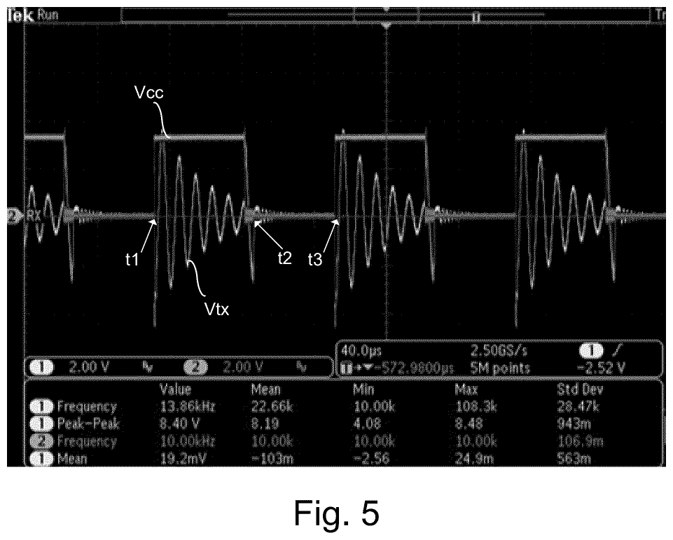

Reference is now made to FIG. 5, which illustrates waveforms according to aspects of the disclosure discussed herein, in this example, circuitry of FIG. 4A. Signal Vcc may be a voltage output by power supply 405A of FIG. 4A. At time t1, a sensor (e.g. NTC temperature sensor 408) may indicate that a potentially unsafe condition may be present, which may cause control circuit 407 to turn transistor Q1 ON, causing inductor L1 and capacitor C3 to oscillate and superimpose AC signal Vtx on conductor 417b. Signal Vtx may decrease in amplitude as capacitor C1 discharges. At time t2, capacitor C1 may be depleted of charge, causing signal Vcc to drop to zero. At time t3, power supply 405A may convert an AC signal superimposed (e.g., by an inverter) on conductor 417a, and recharge capacitor C1, leading to a repetition of the sequence. A system control device (e.g., a control device of an inverter or combiner box coupled to conductors 417a and/or 417b) may detect signal Vtx and take responsive action, for example, sending a shutdown signal to power devices of an energy system, reducing or stopping current and/or power production, and/or the like. In cases where power supply voltage Vcc is provided by a stable power source (e.g. PV power source 450, and/or a battery), signal Vtx might be of substantially constant amplitude and might not decrease in amplitude, and/or might not drop to zero at time t2.

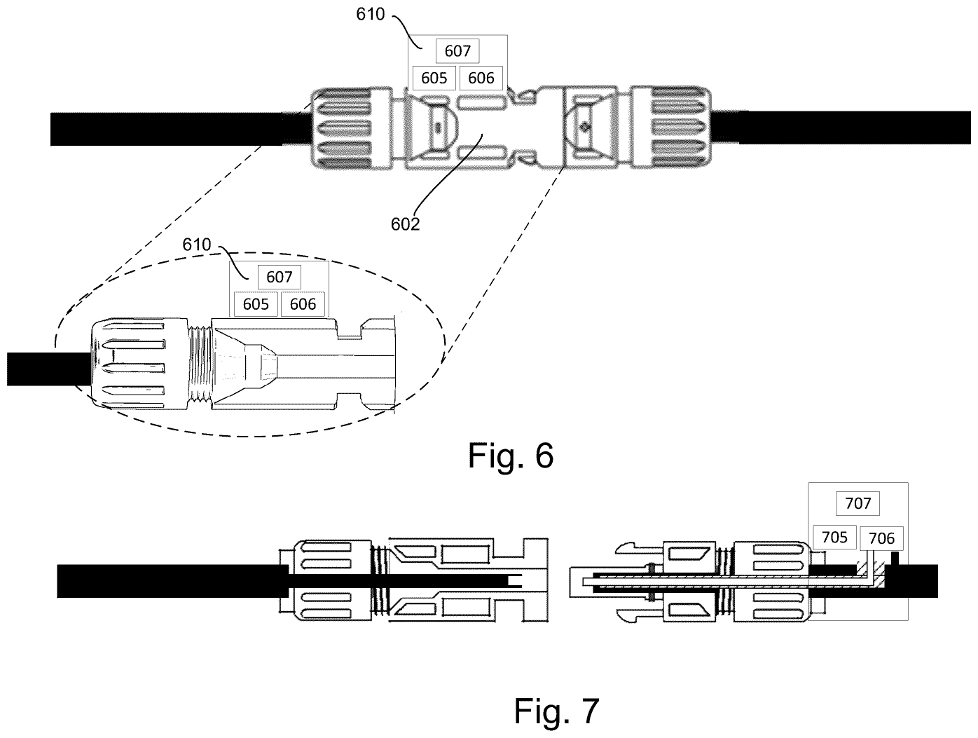

Reference is now made to FIG. 6, which illustrates a connector according to aspects of the disclosure discussed herein. Connector 602 may comprise an enlarged insulating casing including cavity 610. Cavity 610 may house power supply 605, control circuit 607, and communication circuit 606, which may be similar to or the same as power supply 405A, control circuit 407, and communication circuit 406 described above. Connector 602 may be similar to and inter-matable with connectors used in the photovoltaic industry, for example, MC4™ connectors. Where connector 602 is used during installation of an energy system, a temperature sensor may be used as part of control circuit 607, and a separate housing enclosure as described above might not be used.

In some cases, measuring a voltage drop across an electrical connection may enable a fast detection of a poor or faulty connection. In some cases, detecting a potential arcing condition via voltage measurements may be possible before the potential arcing condition would cause a temperature increase detectable according to the features disclosed herein.

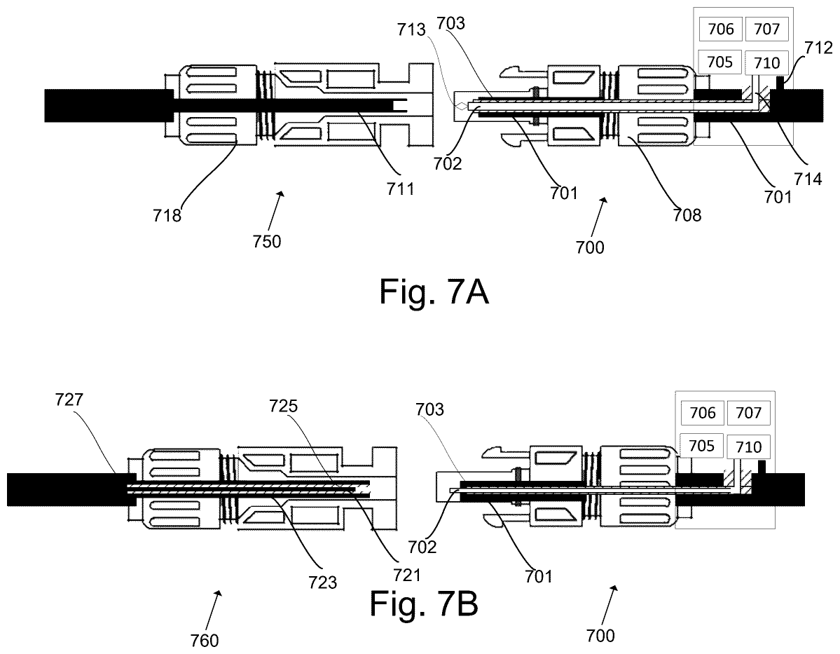

Reference is now made to FIG. 7, which illustrates a connector according to the disclosure herein, which may be configured to enable measuring voltage across an electrical connection. Electrical connector 700 may feature an enclosure 708 formed from electrically insulating material 703. A first conductive element 701 and a second conductive element 702 may be disposed within the electrical connector 700. The first conductive element 701 and second conductive element 702 may be electrically insulated from each other, via electrically insulating material 703, within the electrical connector enclosure 708.

The electrical connector enclosure 708 may configured to mechanically connect to a second electrical connector enclosure. For example, electrical connector enclosure 708 may be mechanically similar to a male MC4™ connector and may be configured to connect to a female MC4™ connector, or electrical connector enclosure 708 may be mechanically similar to a female MC4™ connector and may be configured to connect to a male MC4™ connector. The first conductive element 701 and second conductive element 702 may be positioned to contact one or more corresponding conductive elements 711 when electrical connector enclosure 708 mechanically connects with a second electrical connector enclosure 718. According to features of the disclosure herein, connector 700 may be designed to provide connector voltage sensing capabilities even where second electrical connector 750 and second electrical connector enclosure 718 are generic, i.e. not specifically designed to be intermated to a connector featuring voltage-sensing capabilities. While FIG. 7A shows a specially-designed male connector 700 configured to connect to a generic female connector 750, in other examples of the present disclosure, the specially-designed connector may be a female connector that is configured to connect to a generic male connector. In some cases, the second electrical connector 718 may be specifically designed to enhance the voltage-sensing features of connector 700. The corresponding conductive elements 711 may include a slot for receiving the second conductive element 702, while maintaining contact between the first conductive element 701 and the remaining portion of the corresponding conductive elements 711. This arrangement ensures both the first conductive element 701 and second conductive element 702 maintain electrical contact with the corresponding conductive elements 711, at the same potential when connected.

A voltage sensor 710 may be coupled between a second end of the first conductive element 701 and a second end of the second conductive element 702. The voltage sensor 710 may be, for example, implemented as a voltage divider comprising two resistors (not explicitly depicted). A control circuit 707 may be coupled to the voltage sensor 710. Control circuit 707 may be a digital or an analog control circuit. Control circuit 707 may process measurements from voltage sensor 710 to determine an electrical connection condition between the conductive elements. For example, a constant voltage drop of more than 2 mV, 5 mV or 10 mV may be indicative of a faulty connection.

The first conductive element 701 may be connected to a first contact point through a first wire 712, while the second conductive element 702 connects to a second contact point through a second wire 714. The first wire 712 and second wire 714 may be electrically isolated from each other. A communication circuit 705 may be coupled to the control circuit 707 and may generate an alert upon detection of suspected faulty connection conditions between the first conductive element 701 and the corresponding conductive elements 711. For example, communication circuit 705 may be similar to communication circuit 406 of FIG. 4A and may be triggered by a voltage measurement above a threshold (similar to control circuit 407, described above).

An auxiliary power circuit 706 may be similar to or the same as power supply 405A of FIG. 4A and may provide operational power to the control circuit 707, enabling continuous monitoring capabilities of the electrical connections.

The placement of multiple conductive elements within a single insulated enclosure may provide a space-efficient configuration. The electrical isolation between elements is maintained while reducing overall physical dimensions. The integrated design reduces the total connector footprint compared to separate connectors for each conductive element.

Mechanical connection features of the electrical connector enclosure may guide the conductive elements into proper alignment with corresponding elements. The positioning of the conductive elements may correspond to the mechanical connection points of the enclosure. This coordinated arrangement may reduce the possibility of misaligned or incomplete electrical connections during the connection process and may reduce a risk of electrical arcing, and/or facilitate fast detection of potential electrical arcs.

The voltage sensor and control circuit arrangement may enable continuous monitoring of the electrical connection status. The control circuit processes voltage measurements to detect potential connection issues or faults in real-time. This monitoring capability may operate automatically without requiring manual inspection of the connections.

The integration of sensing and control functions within the connector assembly may provide automated detection capabilities. The control circuit may process the voltage measurements to determine the connection status between conductive elements. The communication circuit 705 may then report any detected connection issues to external systems or operators.

Communication circuit 705 may enable early detection and notification of potential connection issues. By monitoring the electrical connection conditions in real-time, the system can alert users before intermittent or degraded connections develop into complete failures. This proactive notification may enable a power device (e.g. a DC/DC power converter or a DC/AC inverter) to reduce current and/or power flowing through a connector before a faulty connection may cause a fire.

Auxiliary power circuit 706 may enable control circuit 707 to operate without requiring external power connections. This self-contained power arrangement may allow continuous monitoring of the electrical connections regardless of the power state of connected equipment.

Reference is now made to FIG. 7B, which illustrates a second connector 760 according to the aspects of the disclosure discussed herein. Connector 760 may be similar to connector 750 of FIG. 7A, but with corresponding conductive element 711 of FIG. 7A divided into two portions: corresponding sensing conductive portion 721 and corresponding conductive portion 723, wherein corresponding sensing conductive portion 721 is insulated from corresponding conductive portion 723 via insulator 725. Corresponding sensing conductive portion 721 may be connected to corresponding conductive portion 723 at connection point 727, where they together form a conductor for carrying a full current flowing through mated connectors 701 and 760. Connecting corresponding sensing conductive portion 721 to corresponding conductive portion 723 at connection point 727 might reduce a probability of a false negative detection, as distancing the connection point from a potential arcing location may reduce a likelihood of an arcing condition affecting a measured voltage drop between second conductive element 702 and first conductive element 701.

According to features of the disclosure, second conductive element 702 might optionally include conductive spring 713 affixed to the end of second conductive element 702. Conductive spring 713 might be configured to pass through a conductive tube which may be part of a conductor in connector 750 or 760 (e.g. corresponding conductive element 711 of FIG. 7A, or corresponding sensing conductive portion 721 or corresponding conductive portion 723 of FIG. 7B) such that conductive spring 713 is coupled to a conductor of the opposing connector at a point which is distanced from a main contact point between the connectors. The distance may be, for example, 3 mm, 5 mm, 10 mm or more. If a distance between the conductive spring 713 is sufficiently large, and insulating material 703 insulates conductive spring 713 from first conductive element 701, effective detection of a voltage drop in case of arcing may be enabled even in absence of insulator 725. Though not explicitly shown, conductive spring 713 may be featured in connector 701 of FIG. 7A as well.

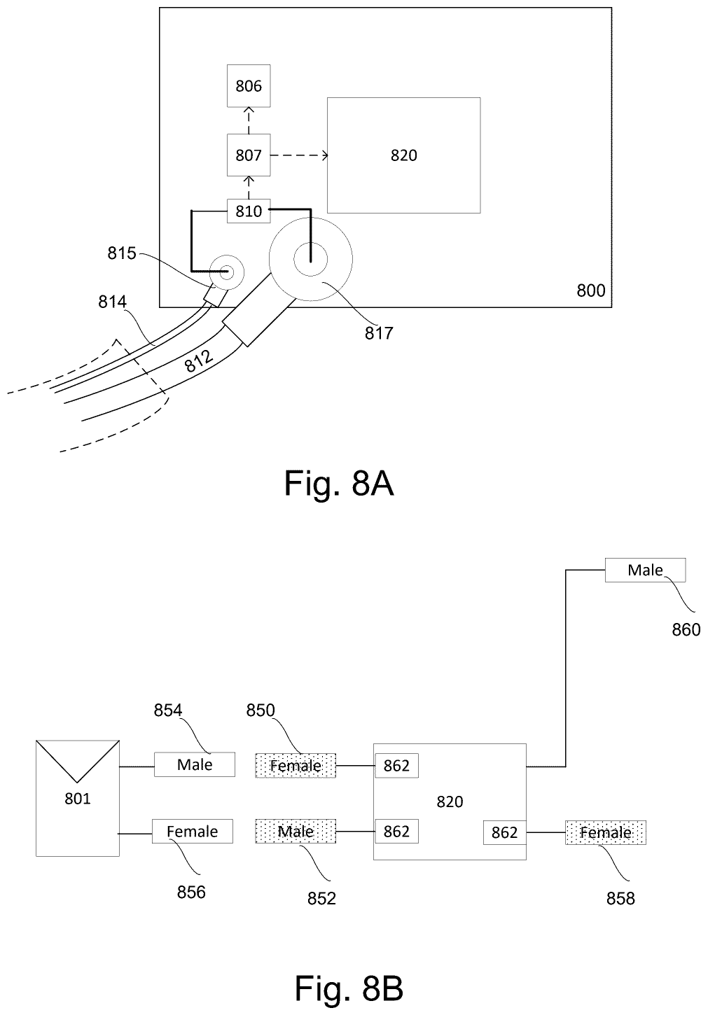

Reference is now made to FIG. 8A, which illustrates part of a system comprising a voltage-detection connector according to aspects of the disclosure discussed herein. Printed circuit board 800 may comprise voltage sensor 810, control circuit 807 and power converter 820. Power terminal 817 may be an input or output power terminal of power converter 820 and may be coupled to conductor 812, which may correspond to an input or output cable of a power device (e.g. a DC/DC power optimizer, a DC/AC inverter, and the like). Conductor 812 may be coupled to a connector having a voltage-sensing circuit, for example, connector 701, 750, or 760 of FIGS. 7A-7B. Sense terminal 815 may be coupled to conductor 814, which in turn may be similar to wire 714 of FIG. 7A. Voltage sensor 810 may measure a voltage between sense terminal 815 and power terminal 817, which may be similar to or the same as a voltage across a pair of intermated connectors having voltage sensing circuitry according to FIGS. 7A and/or 7B. Control circuit 807 may, upon receiving a voltage measurement indicative of a possible arcing condition, operate power converter 820 to reduce or cease processing of power and/or current flowing through conductor 812. Control circuit 807 may operate communication device 806 to raise an alarm to a system control device. Disposing voltage sensor 810, control circuit 807 and communication device 806 on a PCB comprising a power converter rather than in a connector may reduce connector size simplify auxiliary power supply to the voltage sensing and control mechanism, as a PCB comprising a power converter typically may already feature an auxiliary power supply.

Reference is now made to FIG. 8B, which illustrates a power device according to aspects of the disclosure discussed herein. Power converter 820 may comprise a DC/DC converter or a DC/AC converter. Power converter 820 may comprise input terminals 850 and 852, and output terminals 858 and 860. For example, input terminal 850 may be a female connector configured to couple to a male terminal 854 of power source 801 (e.g. a photovoltaic panel or battery). For example, input terminal 852 may be a male connector configured to couple to a female terminal 856 of power source 801. Terminals 850 and 852 may comprise voltage-sensing circuitry as described with respect to FIGS. 7A-7B, and may be configured to detect potentially faulty connections. Connectors 854 and 856 may be generic connectors, or may be designed to enhance faulty-connection capabilities of connectors 850 and 852 (e.g., in accordance with FIG. 7B). Connectors 850, 852 and 858 may comprise integrated voltage-sensing circuitry, as described with respect to FIGS. 7A-7B, and/or may be coupled to voltage-sensing circuitries 862 mounted on a PCB of power converter 820, as described with respect to FIG. 8A. Connector 860 may be configured to intermate with a connector similar to or the same as connector 858, but might not feature integrated voltage-sensing circuitry or be coupled to voltage-sensing circuitry, since when connected to a connector similar to or the same as connector 858, any potential arcing may be detected by the corresponding connector voltage-sensing circuitry. A conductor coupling connector 860 to power converter 820 may be substantially longer than a conductor coupling connector 858 to power converter 820, to enable extending conductors along a series connection of power devices (e.g., to facilitate connection of each power device to a power source 801 which may be large, for example, a solar panel) without comprising voltage sensing capabilities.

Although examples are described above, features and/or steps of those examples may be combined, divided, omitted, rearranged, revised, and/or augmented in any desired manner. Various alterations, modifications, and improvements will readily occur to those skilled in the art. For example, safety enclosures (e.g., safety enclosures 100A, 100B, 200, 400B shown in respective FIGS. 1A, 1B, 2, and 4B) may be designed to fit over generic electrical connectors, and/or to fit over connectors including voltage-sensing capabilities disclosed in FIGS. 6-8B (e.g., connectors 602, 700, 750, 760, 850, 852, 854, 856, 858 and 860). Such alterations, modifications, and improvements are intended to be part of this description, though not expressly stated herein, and are intended to be within the spirit and scope of the disclosure. Accordingly, the foregoing description is by way of example only, and is not limiting.
Clause 1: An apparatus comprising:
an electrical connector enclosure made of electrically insulating material,
a first conductive element disposed within the electrical connector enclosure,
a second conductive element disposed within the electrical connector enclosure, wherein the second conductive element is electrically insulated from the first conductive element,
wherein the electrical connector enclosure is configured to mechanically connect to a second electrical connector enclosure,
wherein the conductive element and the second conductive element are disposed such as to be brought into contact with one or more corresponding conductive elements disposed in the second electrical connector enclosure upon connection of the electrical connector enclosure and the second electrical connector enclosure.
Clause 2: The apparatus of clause 1, wherein a first end of the conductive element and a first end of the second conductive element are disposed such as to be at a common potential when brought into contact with one or more corresponding conductive elements disposed in the second electrical connector enclosure.
Clause 3: The apparatus of any of clauses 1-2, further comprising:
a voltage sensor coupled between a second end of the first conductive element and a second end of the second conductive element,
a control circuit coupled to the voltage sensor and configured to determine, based on one or more measurements received from the voltage sensor, an electrical connection condition of the conductive element and the corresponding conductive element.
Clause 4: The apparatus of clause 3, wherein the voltage sensor and the control circuit are integrated in the electrical connector enclosure.
Clause 5: The apparatus of clause 3, wherein the voltage sensor and control circuit are disposed on a printed circuit board (PCB), wherein the first conductive element is coupled to the PCB at a first contact point and the second conductive element is coupled to the PCB at a second contact point.
Clause 6: The apparatus of clause 5, wherein the conductive element is coupled to the first contact point via a first wire and the second conductive element is coupled to the second contact point via a second wire, wherein the first wire and second wire are electrically insulated from one another.
Clause 7: The apparatus of any of clauses 3-6, further comprising a communication circuit configured to raise an alarm based on a determination of a suspected faulty connection condition between the first conductive element and the corresponding conductive element.
Clause 8: The apparatus of any of clauses 5-7, wherein the control circuit is configured to reduce a current flowing through the first conductive element based on a determination of a suspected faulty connection condition between the first conductive element and the corresponding conductive element.
Clause 9: The apparatus of any of clauses 1-8, wherein the first conductive element is configured to carry more current than the second conductive element.
Clause 10: The apparatus of any of clauses 1-9, wherein the first conductive element and the second conductive element form a coaxial cable arrangement.
Clause 11: The apparatus of any of clauses 3-10, further comprising an auxiliary power circuit configured to provide operational power to the control circuit.
Clause 12: The apparatus of clause 11, wherein the auxiliary power circuit is configured to convert an alternating-current signal superimposed on a current path comprising the first conductive element to direct-current signal operational power.

What is claimed is:

1. An apparatus comprising:
an enclosure configured to fit over an electrical connector, wherein the enclosure comprises:
a controller;
a first coupling circuit configured to be magnetically coupled to a conductor of the electric connector;
a power circuit configured to provide power received via the first coupling circuit to the controller; and
at least one sensor configured to sense a parameter at the electrical connector and provide a measurement to the controller,
wherein the controller is configured to, based on the measurement indicating a potentially unsafe condition, activate a response procedure.

2. The apparatus of claim 1, further comprising a cavity configured to enable at least part of the electrical connector to be housed inside the enclosure.

3. The apparatus of claim 2, wherein the enclosure comprises first and second housing members, wherein the first and second housing members are configured to mechanically interconnect.

4. The apparatus of claim 3, further comprising a hinge interconnecting the first and second housing members.

5. The apparatus of claim 3, further comprising a hinge interconnecting first edges of the first and second housing members and a snap-close mechanism configured to interconnect second edges of the first and second housing members.

6. The apparatus of claim 3, wherein the cavity is configured to house the entire electrical connector, and further comprising cable guides at third and fourth edges of the first and second housing members.

7. The apparatus of claim 6, wherein the cable guides are configured to seal around a photovoltaic cable upon of the first and second housing members.

8. The apparatus of claim 1, wherein the enclosure is between 3.5 and 6 inches long.

9. The apparatus of claim 2, wherein the cavity is configured to house only a portion of the electrical connector, and the enclosure terminates at an inner portion of the connector.

10. The apparatus of claim 9, wherein the enclosure is less than two inches long.

11. The apparatus of claim 3, wherein the enclosure comprises an inner surface and an outer surface.

12. The apparatus of claim 11, wherein the sensor includes a temperature sensor disposed between the inner surface and the outer surface.

13. The apparatus of claim 11, wherein the sensor includes a temperature sensor disposed on the inner surface.

14. The apparatus of claim 11, wherein the sensor includes a light sensor disposed on the inner surface.

15. The apparatus of claim 11, wherein the inner surface comprises a fire-retardant lining.

16. A method comprising:
disposing an enclosure comprising a sensor around an electrical connection formed by a first and second mechanical connectors comprising respective first and second conductive elements,
wherein the sensor is configured to indicate a faulty electrical connection.

17. The method of claim 16, wherein the sensor is a temperature sensor, and the sensor is configured to cause, upon sensing a temperature above a temperature threshold, a signal to be sent to a controller.

18. A system comprising:
a system control device;
a first connector and a second connector, wherein the first connector and the second connector are configured to be intermated such that, upon connection of the first and second connectors, an electrical connection is formed; and
an enclosure disposed around the electrical connection, wherein the enclosure comprises a sensor, a power supply, a control device and a communication device, wherein the control device is configured to operate the communication device to signal the system control device upon the sensor indicating a potentially faulty connection.

19. The system of claim 18, wherein the system control device is part of a direct current (DC) to alternating current (AC) power inverter coupled to a DC input, wherein at least one of the first and second connectors are coupled to a DC power source configured to provide DC power to the DC input.

20. The system of claim 18,
wherein the first connector comprises:
a first electrical connector enclosure made of electrically insulating material;
a first conductive element disposed within the first electrical connector enclosure; and
a second conductive element disposed within the first electrical connector enclosure,
wherein the second conductive element is electrically insulated from the first conductive element,
wherein the first electrical connector enclosure is configured to mechanically connect to a second electrical connector enclosure of the second connector, and
wherein the conductive element and the second conductive element are disposed such as to be brought into contact with one or more corresponding conductive elements disposed in the second electrical connector enclosure upon connection of the first electrical connector enclosure and the second electrical connector enclosure.
